(19) United States
(12) Patent Application Publication
(10) Pub. No.: US 2008/0093846 A1
(43) Pub. Date: Apr. 24, 2008

(54) Clampless tube connection with integrated sealing and locking feature

(76) Inventors: Joshua Sparks, Southgate, MI (US); Charles Bryan Peterson, White Lake, MI (US); David S. Moyer, Sterling Heights, MI (US); Anthony Charles Arruda, Ann Arbor, MI (US); Aamir Marvi, Northville, MI (US); John Christian Sorensen, Dearborn, MI (US); David John Moenssen, Columbus, IN (US)

Correspondence Address: FRASER CLEMENS MARTIN & MILLER LLC, 28366 KENSINGTON LANE, PERRYSBURG, OH, 43551, US

(21) Appl. No.: 11/498,391

(22) Filed: Aug. 3, 2006

(51) Int. Cl. F16L 37/08

(52) U.S. Cl. 285/330

(57) ABSTRACT

A clampless tube connection is disclosed, wherein at least one of a conduit and a tube has integrated sealing and locking features.

### FIELD OF THE INVENTION

The present invention relates to a clampless tube connection and more particularly to a clampless tube connection with integrated sealing and locking features for connection to a conduit.

### BACKGROUND OF THE INVENTION

It is common practice to employ flexible hose or tubing between relatively rigid and stationary parts so that the hose or tubing forms a conduit for the transfer of fluids therebetween. The flexible tubing facilitates use of less stringent dimensional standards between parts. A typical example is the use of flexible tubing for connection to an air cleaner.

Tube clamps such as worm gear clamps, constant tension clamps, or wire clamps are used at areas of interconnection. The strategy for connecting the conduit and tube requires the use of additional parts which add to the complexity of assembly and require additional assembly time.

It is therefore considered desirable to produce a tube for interconnecting rigid and stationary parts that includes integrated sealing and locking features, wherein the connection permits the transfer of fluids therebetween.

### SUMMARY OF THE INVENTION

Harmonious with the present invention, a tube for interconnecting rigid and stationary parts that includes integrated sealing and locking features, wherein the connection permits the transfer of fluids therebetween has surprisingly been discovered.

In one embodiment, a conduit comprises a hollow tube having a first end and a second end; a hollow conduit adapted to be connected to the first end of the tube; a connecting structure formed on one of the tube and the conduit, the connecting structure adapted to engage the other of the tube and the conduit to militate against a separation of the tube and the conduit; and a sealing structure disposed between the tube and the conduit to facilitate a substantially fluid tight seal therebetween.

In another embodiment, a conduit comprises a hollow tube having a first end and a second end; a hollow conduit adapted to be connected to the first end of the tube; a connecting structure formed on one of the tube and the conduit, the connecting structure adapted to engage the other of the tube and the conduit to militate against a separation of the tube and the conduit, wherein a wall of one of the tube and the conduit includes an aperture formed therein for receiving the connecting structure formed on the other of the tube and the conduit; and a sealing structure disposed between the tube and the conduit to facilitate a substantially fluid tight seal therebetween.

In another embodiment, a conduit comprises a hollow conduit having a first end and a second end; a tube adapted to be connected to the first end of the conduit; a connecting structure formed on one of the conduit and the tube, the connecting structure adapted to engage the other of the conduit and the tube to militate against a separation of the conduit and the tube; and a sealing structure disposed between the conduit and the tube to facilitate a substantially fluid tight seal therebetween.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a fragmentary perspective view of a tube showing a portion in section in accordance with an embodiment of the invention;

FIG. 2 is a fragmentary perspective view of a conduit for connecting to the tube shown in FIG. 1;

FIG. 3 is a fragmentary sectional view of the tube shown in FIG. 1 assembled with the conduit shown in FIG. 2;

FIG. 4 is a perspective view of a tube and a conduit according to another embodiment of the invention;

FIG. 5 is a perspective view of a tube and a conduit according to another embodiment of the invention;

FIG. 6 is a perspective view of a tube and a conduit according to another embodiment of the invention;

FIG. 7 is a perspective view of a tube and a conduit according to another embodiment of the invention;

FIG. 8 is an exploded sectional view of the tube and the conduit shown in FIG. 7;

FIG. 9 is a perspective view of a tube and a conduit according to another embodiment of the invention;

FIG. 10 is a perspective view of a tube and a conduit according to another embodiment of the invention;

FIG. 11 is a fragmentary sectional view of the tube shown in FIG. 10 assembled with the conduit shown in FIG. 10.

FIG. 12 is a perspective view of a tube and a conduit according to another embodiment of the invention; and

FIG. 13 is a fragmentary sectional view of the tube shown in FIG. 12 assembled with the conduit shown in FIG. 12.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

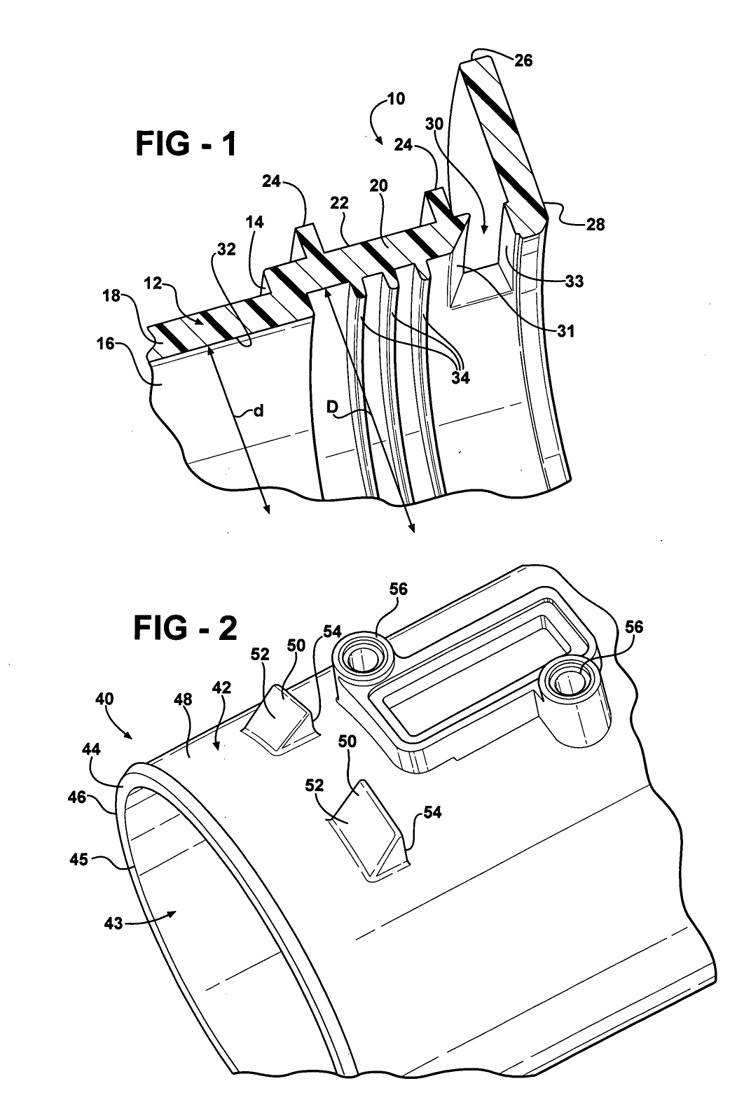

FIG. 1 shows a tube 10 according to an embodiment of the invention, such as a clean air tube, for example. In the embodiment shown, the tube 10 is formed from rubber, although other flexible materials may be used as desired. The tube 10 includes a wall 12 having a shoulder 14 formed thereon, and forms a hollow interior 16. An inner diameter d of the tube 10 on a first side 18 of the shoulder 14 is smaller than an inner diameter D of a second side 20 of the shoulder 14. An outer surface 22 of the wall 12 includes a plurality of radially outwardly extending protuberances 24. A distal end 28 of the tube 10 has a radially outwardly extending flange 26 formed thereon. At least one aperture 30 is formed in the wall 12 between the protuberances 24 and the flange 26. It is understood that the aperture 30 can be formed in other locations such as between adjacent protuberances 24, for example, without departing from the spirit or scope of the invention. The wall 12 surrounding the aperture 30 includes a sloped first surface 31 and a substantially flat second surface 33. An inner surface 32 of the wall 12 includes a plurality of radially inwardly extending sealing structure 34. The sealing structure 34 shown are radially inwardly extending protuberances. However, other sealing structure can be used as desired.

FIG. 2 shows a conduit 40 according to an embodiment of the invention, such as an outlet of an air cleaner box, for example. In the embodiment shown, the conduit 40 is formed from plastic, although it is understood that other materials may be used as desired. The conduit 40 includes a wall 42 having a hollow interior 43, an inner surface 45, and an outer surface 48. A radially outwardly extending lip 44 is formed at a distal end 46 of the conduit 40. The outer surface 48 of the conduit 40 includes at least one radially outwardly extending protuberance 50 formed thereon. It is understood that the conduit 40 includes a corresponding number of protuberances 50 as apertures 30 formed in the tube 10. The protuberance includes a sloped first surface 52 and a substantially flat second surface 54. Optionally, the wall 42 of the conduit 40 can also include at least one aperture 56 formed thereon for receiving a fastening screw (not shown).

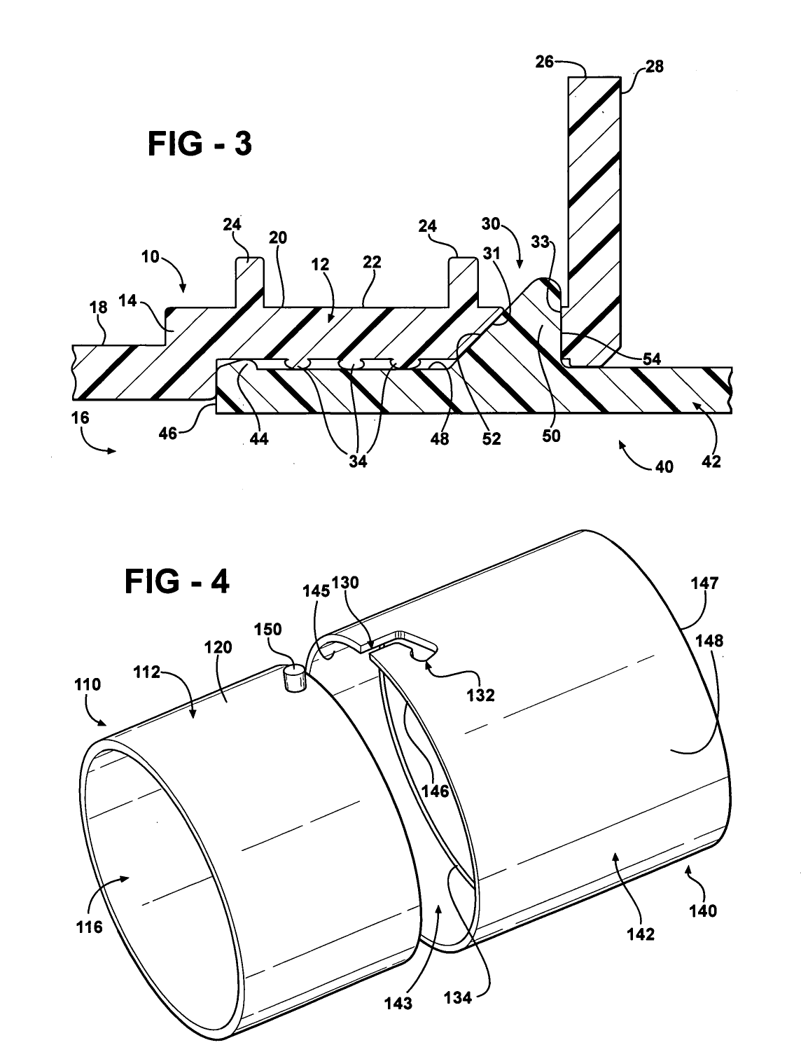

When assembled as shown in FIG. 3, the outer surface 48 of the wall 42 of the conduit 40 is received in the hollow interior 16 of the tube 10. The protuberances 50 of the conduit 40 are received by the apertures 30 formed in the tube 10. The sloped first surface 52 of the conduit 40 seats against the sloped first surface 31 of the wall 12 of the tube 10, and the substantially flat second surface 54 of the conduit 40 seats against the substantially flat second surface 33 of the wall 12 of the tube 10. An end of the lip 44 of the conduit 40 abuts an inner surface of the shoulder 14 formed on the wall 12 of the tube 10. The sealing structure 34 of the tube 10 engages the outer surface 48 of the wall 42 of the conduit 40 to form a substantially fluid tight seal therebetween. It is understood that the aperture 30 formed on the tube 10 can be formed on the conduit 40 and the protuberance 50 formed on the conduit 40 can be formed on the tube 10. In this case, the flange 26 would also be formed on the conduit 40, the outer surface 22 of the tube 10 would be received in the hollow interior 43 of the conduit 40, and the sealing structure 34 would be formed on the inner surface 45 of the conduit 40. It is also understood that the sealing structure 34 could be formed on the outer surface 48 of the wall 42 of the conduit 40 without departing from the spirit or scope of the invention.

In use, the tube 10 is joined to the conduit 40 by inserting the end 46 of the conduit 40 into the tube 10. The end 46 of the conduit 40 slides into the tube 10 until the protuberances 50 of the conduit 40 are received in the apertures 30 of the tube 10. The seating of the first surfaces 31, 52 and second surfaces 33, 54 of the wall 12 and the protuberance 50 militates against relative movement between the tube 10 and the conduit 40. The sealing engagement between the sealing structure 34 of the tube 10 and the outer surface 48 of the wall 42 of the conduit 40 allow for a fluid (not shown) to flow through the tube 10 and the conduit 40 and militates against leakage of the fluid therefrom. The aperture 56 formed in the conduit 40 receives the fastening screw and permits the conduit 40 to be connected to an additional part (not shown). Accordingly, a substantially fluid tight locked connection is established between the tube 10 and the conduit 40. If it is desired to detach the tube 10 from the conduit 40, the flange 26 of the tube 10 or the protuberances 24 are simultaneously gripped to pull the conduit 40 and the tube 10 away from one another and detach the conduit 40 from the tube 10.

The connection between the tube 10 and the conduit 40 is made without the use of additional structure such as worm gear clamps, constant tension clamps, or wire clamps as used in prior art connections. Accordingly, a cost of materials and a time of assembly are minimized.

FIG. 4 shows a conduit 110 and a tube 140 in accordance with another embodiment of the invention. In this embodiment, a wall 112 of the conduit 110 forms a hollow interior 116. A protuberance 150 is formed on an outer surface 120 of the wall 112.

The tube 140 has a longitudinal axis L and includes a wall 142 forming a hollow interior 143, an inner surface 145, and an outer surface 148. A distal end 146 of the tube 140 includes a substantially L-shaped aperture 130 formed therein. The aperture 130 extends axially from the distal end 146 of the wall 142. At a predetermined distance, the aperture 130 extends laterally, and then axially towards the end 146 to terminate at a locking slot 132. The inner surface 145 of the tube 140 includes at least one radially inwardly extending sealing structure 134 formed thereon for sealingly engaging the outer surface 120 of the wall 112 of the conduit 110.

To assemble, the protuberance 150 is aligned with the aperture 130. The conduit 110 and the tube 140 are joined and twisted to position the protuberance 150 formed on the conduit 110 in the locking slot 132 of the aperture 130. The sealing structure 134 of the tube 140 engages the outer surface 120 of the wall 112 of the conduit 110 to form a substantially fluid tight seal therebetween. The protuberance 150 and aperture 130 can be formed on either of the conduit 110 and the tube 140 without departing from the spirit or scope of the invention. It is also understood that the sealing structure 134 could be formed on the outer surface 120 of the wall 112 of the conduit 110 without departing from the spirit or scope of the invention.

In use, the twist locking described above militates against relative movement between the conduit 110 and the tube 140. The sealing structure 134 formed on the inner surface 145 of the wall 142 of the tube 140 sealingly engages the outer surface 120 of the wall 112 of the conduit 110 and militates against fluid leakage therebetween. The sealing engagement between the sealing structure 134 of the tube 140 and the outer surface 120 of the wall 112 of the conduit 110 allows for a fluid (not shown) to flow through the conduit 110 and the tube 140. Accordingly, the substantially fluid tight locked connection is established between the conduit 110 and the tube 140. If it is desired to detach the conduit 110 from the tube 140, the conduit 110 can be pushed together with the tube 140, then twisted and pulled away from the tube 140.

The connection between the conduit 110 and the tube 140 is made without the use of additional structure such as worm gear clamps, constant tension clamps, or wire clamps as used in prior art connections. Accordingly, a cost of materials and a time of assembly are minimized.

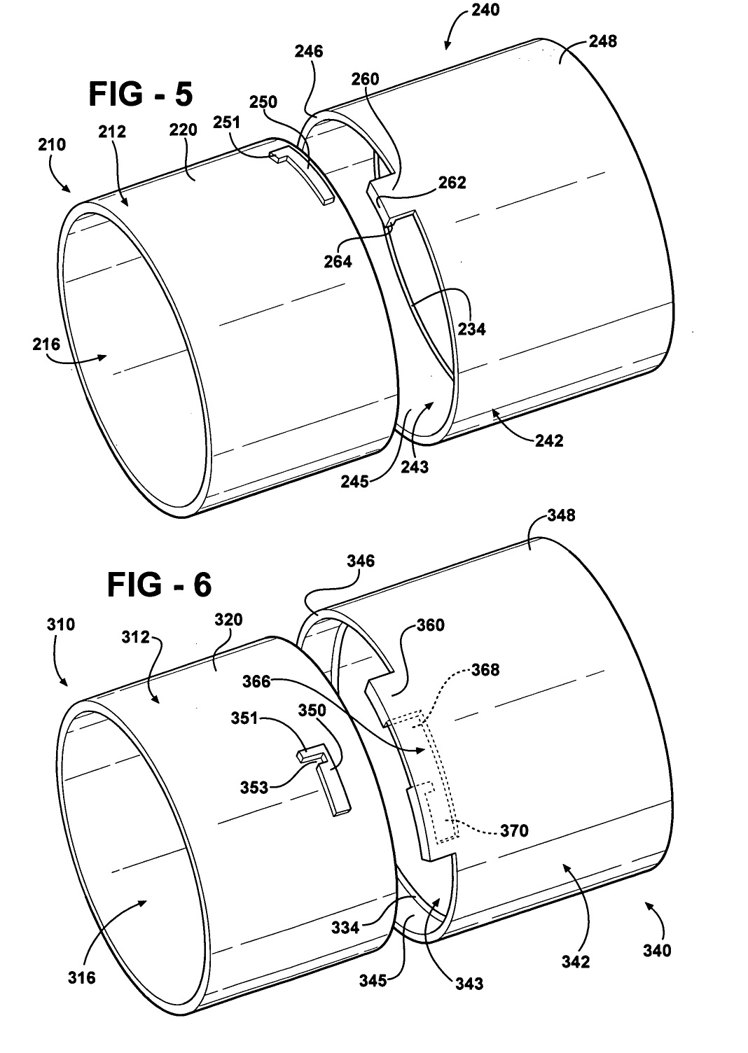

FIG. 5 shows a conduit 210 and a tube 240 in accordance with another embodiment of the invention. In this embodiment, a wall 212 of the conduit 210 forms a hollow interior 216. An outer surface 220 of the conduit 210 includes a protuberance 250 having a lip 251.

The tube 240 has a longitudinal axis L and includes a wall 242 forming a hollow interior 243, an inner surface 245, and an outer surface 248. A distal end 246 of the tube 240 includes a protuberance 260 formed thereon. A distal end 262 of the protuberance 260 has a lip 264 formed thereon. The lip 264 is adapted to abut the lip 251 formed on the conduit 210. The inner surface 245 of the tube 240 includes at least one radially inwardly extending sealing structure 234 formed thereon for sealingly engaging the outer surface 220 of the wall 212 of the conduit 210.

To assemble, the protuberance 250 is aligned adjacent to the protuberance 260. The conduit 210 and the tube 240 are joined and twisted to abut the lip 264 with the lip 251. The sealing structure 234 of the tube 240 engages the outer surface 220 of the wall 212 of the conduit 210 to form a substantially fluid tight seal therebetween. The protuberances 250, 260 can be formed on either of the conduit 210 and the tube 240 without departing from the spirit or scope of the invention. It is also understood that the sealing structure 234 could be formed on the outer surface 220 of the wall 212 of the conduit 210 without departing from the spirit or scope of the invention.

In use, the twist locking described above militates against relative movement between the conduit 210 and the tube 240. The sealing structure 234 formed on the inner surface 245 of the wall 242 of the tube 240 sealingly engages the outer surface 220 of the wall 212 of the conduit 210 and militates against fluid leakage therebetween. The sealing engagement between the sealing structure 234 of the tube 240 and the outer surface 220 of the wall 212 of the conduit 210 allows for a fluid (not shown) to flow through the conduit 210 and the tube 240. Accordingly, the substantially fluid tight locked connection is established between the conduit 210 and the tube 240. If it is desired to detach the conduit 210 from the tube 240, the conduit 210 can be twisted and then pulled away from the tube 240.

The connection between the conduit 210 and the tube 240 is made without the use of additional structure such as worm gear clamps, constant tension clamps, or wire clamps as used in prior art connections. Accordingly, a cost of materials and a time of assembly are minimized.

FIG. 6 shows a conduit 310 and a tube 340 in accordance with another embodiment of the invention. In this embodiment, a wall 312 of the conduit 310 forms a hollow interior 316. An outer surface 320 of the conduit 310 includes a protuberance 350 having a lip 351 and an indent 353.

The tube 340 has a longitudinal axis and includes a wall 342 forming a hollow interior 343, an inner surface 345, and an outer surface 348. A distal end 346 of the tube 340 includes a protuberance 360 formed thereon. The protuberance 360 has an aperture 366 having a first section 368 and a second section 370 formed therein. The first section 368 accommodates the protuberance 350 formed on the conduit 310 therein. The second section 370 is adapted to receive the protuberance 350 formed on the conduit 310 to militate against relative movement therebetween. The inner surface 345 of the tube 340 includes at least one radially inwardly extending sealing structure 334 formed thereon for sealingly engaging the outer surface 320 of the wall 312 of the conduit 310.

To assemble, the protuberance 350 is aligned with the first section 368 of the aperture 366. The conduit 310 and the tube 340 are joined and twisted to position the protuberance 350 in the second section 370 of the aperture 366. The sealing structure 334 of the tube 340 engages the outer surface 320 of the wall 312 of the conduit 310 to form a substantially fluid tight seal therebetween. The protuberances 350, 360 can be formed on either of the conduit 310 and the tube 340 without departing from the spirit or scope of the invention. It is also understood that the sealing structure 334 could be formed on the outer surface 320 of the wall 312 of the conduit 310 without departing from the spirit or scope of the invention.

In use, the twist locking described above militates against relative movement between the conduit 310 and the tube 340. The sealing structure 334 formed on the inner surface 345 of the wall 342 of the tube 340 sealingly engages the outer surface 320 of the wall 312 of the conduit 310 and militates against fluid leakage therebetween. The sealing engagement between the sealing structure 334 of the tube 340 and the outer surface 320 of the wall 312 of the conduit 310 allows for a fluid (not shown) to flow through the conduit 310 and the tube 340. Accordingly, a substantially fluid tight locked connection is established between the conduit 310 and the tube 340. If it is desired to detach the conduit 310 from the tube 340, the conduit 310 can be pushed toward the tube 340 and twisted and pulled away from the tube 340.

The connection between the conduit 310 and the tube 340 is made without the use of additional structure such as worm gear clamps, constant tension clamps, or wire clamps as used in prior art connections. Accordingly, a cost of materials and a time of assembly are minimized.

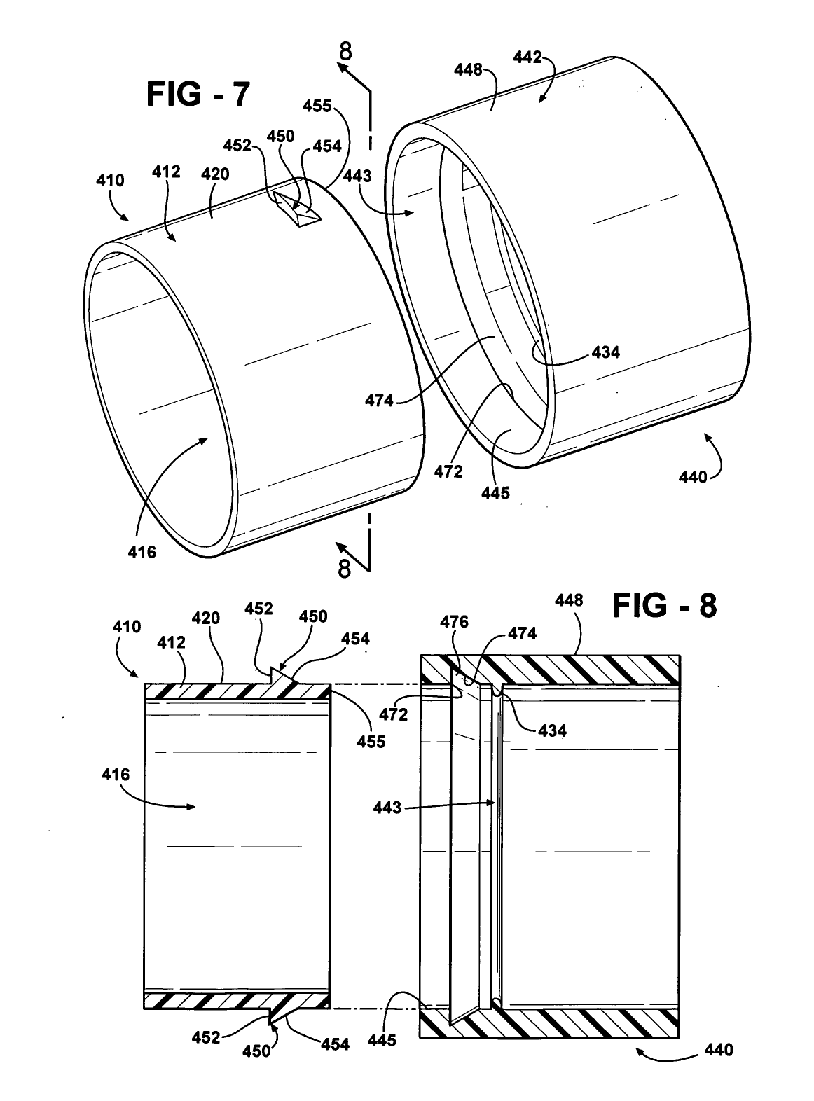

FIGS. 7 and 8 show a conduit 410 and a tube 440 in accordance with another embodiment of the invention. In this embodiment, a wall 412 of the conduit 410 forms a hollow interior 416. An outer surface 420 of the conduit 410 includes a protuberance 450 formed thereon and terminates in a distal end 455. The protuberance has a first side 452 that is substantially flat and a second surface 454 that is sloped.

The tube 440 has a longitudinal axis L and includes a wall 442 forming a hollow interior 443, an inner surface 445, and an outer surface 448. The inner surface 445 includes a channel 472 and at least one radially inwardly extending sealing structure 434 formed thereon. An end 476 of the channel 472 has a sloped surface 474 for receiving second surface 454 of the protuberance 450 formed on the conduit 410. The sealing structure 434 is adapted to sealingly engage the outer surface 420 of the conduit 410.

To assemble, the protuberance 450 is aligned with the channel 472. The conduit 410 and the tube 440 are joined and the protuberance 450 is received in the channel 472. The substantially flat first surface 452 of the protuberance 450 abuts the channel 472, and the sloped second surface 454 of the protuberance 450 seats against the sloped surface 474 of the channel 472. The sealing structure 434 of the tube 440 engages the outer surface 420 of the wall 412 of the conduit 410 to form a substantially fluid tight seal therebetween. The protuberance 450 and the channel 472 can be formed on either of the conduit 410 and the tube 440 without departing from the spirit or scope of the invention. It is also understood that the sealing structure 434 could be formed on the outer surface 420 of the wall 412 of the conduit 410 without departing from the spirit or scope of the invention.

In use, the locking described above militates against relative movement between the conduit 410 and the tube 440. The sealing structure 434 formed on the inner surface 445 of the wall 442 of the tube 440 sealingly engages the outer surface 420 of the wall 412 of the conduit 410 and militates against fluid leakage therebetween. The sealing engagement between the sealing structure 434 of the tube 440 and the outer surface 420 of the wall 412 of the conduit 410 allows for a fluid (not shown) to flow between the conduit 410 and the tube 440. Accordingly, a substantially fluid tight locked connection is established between the conduit 410 and the tube 440. If it is desired to detach the conduit 410 from the tube 440, the tube 440 can be squeezed to move the protuberance 450 out of the channel 472 formed in the tube 440 wherein the conduit 410 is simultaneously pulled away from the tube 440.

The connection between the conduit 410 and the tube 440 is made without the use of additional structure such as worm gear clamps, constant tension clamps, or wire clamps as used in prior art connections. Accordingly, a cost of materials and a time of assembly are minimized.

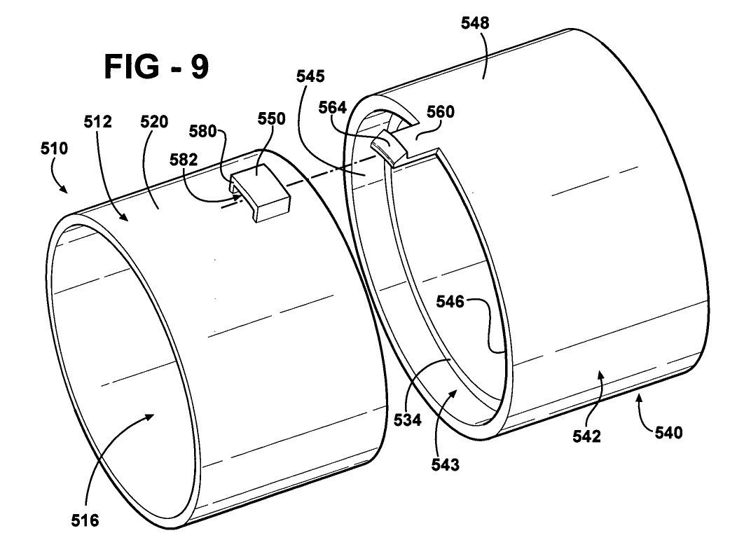

FIG. 9 shows a conduit 510 and a tube 540 in accordance with another embodiment of the invention. In this embodiment, a wall 512 of the conduit 510 forms a hollow interior 516. An outer surface 520 of the conduit 510 includes a radially outwardly extending protuberance 550 having an upper wall 580 and an aperture 582 formed therein.

The tube 540 has a longitudinal axis L and includes a wall 542 forming a hollow interior 543, an inner surface 545, and an outer surface 548. A distal end 546 of the tube 540 includes a radially outwardly extending protuberance 560 formed thereon. The protuberance 560 includes a lip 564 adapted to engage the upper wall 580 of the protuberance 550 formed on the conduit 510. A sealing structure 534 formed on an inner surface 545 is adapted to sealingly engage the outer surface 520 of the wall 512 of the conduit 510.

To assemble, the aperture 582 is aligned with the protuberance 560 and the conduit 510 and the tube 540 are joined. The aperture 582 receives the protuberance 560 and the lip 564 abuts the upper wall 580 of the protuberance 550. The sealing structure 534 of the tube 540 engages the outer surface 520 of the wall 512 of the conduit 510 to form a substantially fluid tight seal therebetween. The protuberances 550, 560 can be formed on either of the conduit 510 and the tube 540 without departing from the spirit or scope of the invention. It is also understood that the sealing structure 534 could be formed on the outer surface 520 of the wall 512 of the conduit 510 without departing from the spirit or scope of the invention.

In use, the locking described above militates against relative movement between the conduit 510 and the tube 540. The sealing structure 534 formed on the inner surface 545 of the wall 542 of the tube 540 sealingly engages the outer surface 520 of the wall 512 of the conduit 510 and militates against fluid leakage therebetween. The sealing engagement between the sealing structure 534 of the tube 540 and the outer surface 520 of the wall 512 of the conduit 510 allows for a fluid (not shown) to flow between the conduit 510 and the tube 540. Accordingly, a substantially fluid tight locked connection is established between the conduit 510 and the tube 540. If it is desired to detach the conduit 510 from the tube 540, the lip 564 of the protuberance 560 formed on the tube 540 can be squeezed to move the lip 564 below the upper wall 580 of the protuberance 550 formed on the conduit 510 and the conduit 510 is simultaneously pulled away from the tube 540.

The connection between the conduit 510 and the tube 540 is made without the use of additional structure such as worm gear clamps, constant tension clamps, or wire clamps as used in prior art connections. Accordingly, a cost of materials and a time of assembly are minimized.

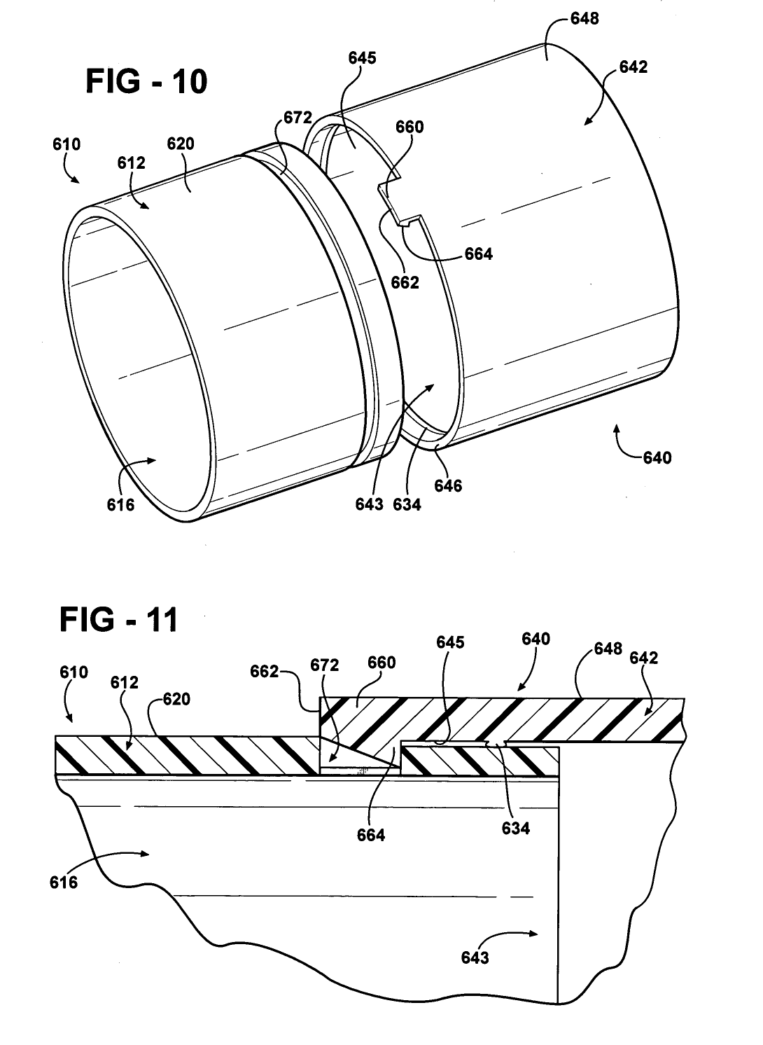

FIGS. 10 and 11 show a conduit 610 and a tube 640 in accordance with another embodiment of the invention. In this embodiment, a wall 612 of the conduit 610 forms a hollow interior 616. An outer surface 620 of the conduit 610 includes a channel 672 formed therein.

The tube 640 has a longitudinal axis L and includes a wall 642 forming a hollow interior 643, an inner surface 645, and an outer surface 648. A distal end 646 of the tube 640 includes a protuberance 660 formed thereon. A distal end 662 of the protuberance 660 includes a lip 664 adapted to be received in the channel 672 formed in the conduit 610. A sealing structure 634 formed on the inner surface 645 is adapted to sealingly engage the outer surface 620 of the conduit 610.

To assemble, the protuberance 660 is aligned with the channel 672. The conduit 610 and the tube 640 are joined and the lip 664 is received in the channel 672. The sealing structure 634 of the tube 640 engages the outer surface 620 of the wall 612 of the conduit 610 to form a substantially fluid tight seal therebetween. The protuberance 660 and the channel 672 can be formed on either of the conduit 610 and the tube 640 without departing from the spirit or scope of the invention. It is also understood that the sealing structure 634 could be formed on the outer surface 620 of the wall 612 of the conduit 610 without departing from the spirit or scope of the invention.

In use, the locking described above militates against relative movement between the conduit 610 and the tube 640. The sealing structure 634 formed on the inner surface 645 of the wall 642 of the tube 640 sealingly engages the outer surface 620 of the wall 612 of the conduit 610 and militates against fluid leakage therebetween. The sealing engagement between the sealing structure 634 of the tube 640 and the outer surface 620 of the wall 612 of the conduit 610 allows for a fluid (not shown) to flow between the conduit 610 and the tube 640. Accordingly, a substantially fluid tight locked connection is established between the conduit 610 and the tube 640. If it is desired to detach the conduit 610 from the tube 640, the tube 640 can be squeezed to move the lip 664 formed in the tube 640 out of the channel 672, wherein the conduit 610 is simultaneously pulled away from the tube 640.

The connection between the conduit 610 and the tube 640 is made without the use of additional structure such as worm gear clamps, constant tension clamps, or wire clamps as used in prior art connections. Accordingly, a cost of materials and a time of assembly are minimized.

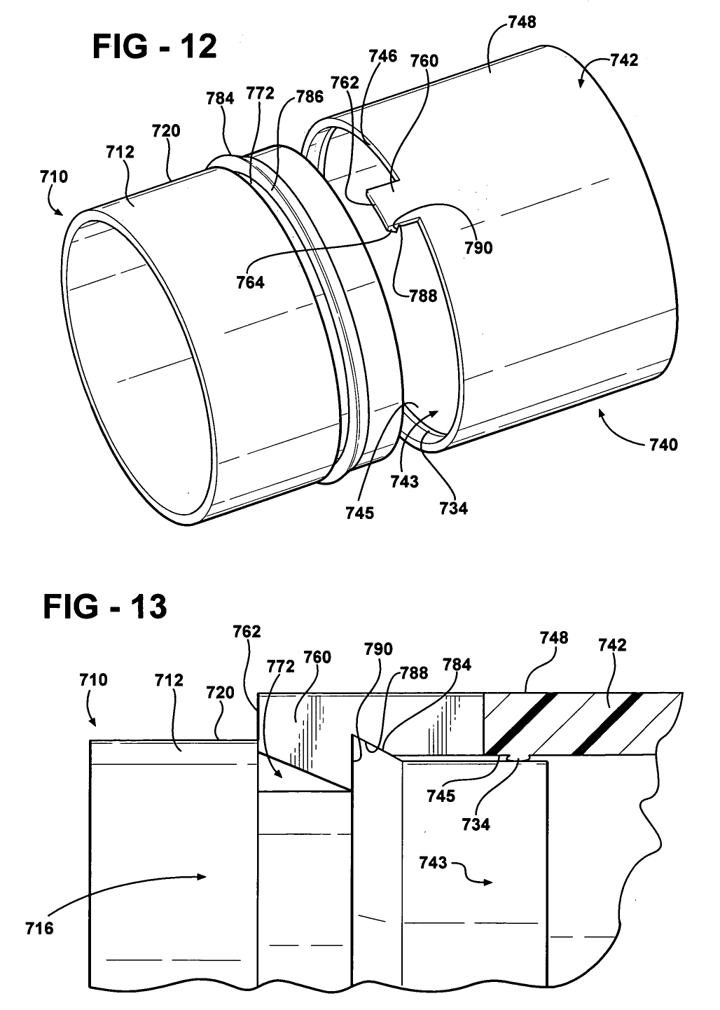

FIGS. 12 and 13 show a conduit 710 and a tube 740 in accordance with another embodiment of the invention. In this embodiment, a wall 712 of the conduit 710 forms a hollow interior 716. An outer surface 720 of the conduit 710 includes a channel 772 formed therein. A lip 784 is formed around an outer edge 786 of the channel 772.

The tube 740 has a longitudinal axis L and includes a wall 742 forming a hollow interior 743, an inner surface 745 and an outer surface 748. A distal end 746 of the tube 740 includes a protuberance 760 formed thereon. A distal end 762 of the protuberance 760 includes a lip 764 having a groove 788 formed at a first end 790 thereof. The lip 764 is adapted to be received in the channel 772 formed in the conduit 710, and the groove 788 is adapted to receive the lip 784 formed on the conduit 710. A sealing structure 734 formed on the inner surface 745 is adapted to sealingly engage the outer surface 720 of the conduit 710.

To assemble, the protuberance 760 is aligned with the channel 772 and the conduit 710 and the tube 740 are joined. The lip 764 formed on the tube 740 is received in the channel 772 of the conduit 710 and the lip 784 formed on the conduit 710 is received by the groove 788 formed in the tube 740. The sealing structure 734 of the tube 740 engages the outer surface 720 of the wall 712 of the conduit 710 to form a substantially fluid tight seal therebetween. The protuberance 760 and the channel 772 can be formed on either of the conduit 710 and the tube 740 without departing from the spirit or scope of the invention. It is also understood that the sealing structure 734 could be formed on the outer surface 720 of the wall 712 of the conduit 710 without departing from the spirit or scope of the invention.

In use, the locking described above militates against relative movement between the conduit 710 and the tube 740. The sealing structure 734 formed on the inner surface 745 of the wall 742 of the tube 740 sealingly engages the outer surface 720 of the wall 712 of the conduit 710 and militates against fluid leakage therebetween. The sealing engagement between the sealing structure 734 of the tube 740 and the outer surface 720 of the wall 712 of the conduit 710 allows for a fluid (not shown) to flow between the conduit 710 and the tube 740. Accordingly, a substantially fluid tight locked connection is established between the conduit 710 and the tube 740. If it is desired to detach the conduit 710 from the tube 740, the tube 740 can be squeezed to move the lip 764 formed in the tube 740 out of the channel 772 and the lip 784 out of the groove 788 formed in the tube 740, wherein the conduit 710 is simultaneously pulled away from the tube 740.

The connection between the conduit 710 and the tube 740 is made without the use of additional structure such as worm gear clamps, constant tension clamps, or wire clamps as used in prior art connections. Accordingly, a cost of materials and a time of assembly are minimized.

The structure discussed above that is employed to join and lock the conduits 40, 110, 210, 310, 410, 510, 610, 710, together with the tubes 10, 140, 240, 340, 440, 540, 640, 740 is collectively referred to as connecting structure.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A conduit comprising:
a hollow conduit having a first end and a second end;
a hollow tube adapted to be connected to the first end of the conduit;
a connecting structure formed on one of the tube and the conduit, the connecting structure adapted to engage the other of the tube and the conduit to militate against a separation of the tube and the conduit; and
a sealing structure disposed between the tube and the conduit to facilitate a substantially fluid tight seal therebetween.

2. The conduit as defined in claim 1, wherein the connecting structure is a protuberance.

3. The conduit as defined in claim 2, wherein the protuberance is formed on an outer portion of a wall of one of the tube and the conduit.

4. The conduit as defined in claim 1, wherein the detent is a locking tab.

5. The conduit as defined in claim 4, wherein the locking tab is formed on an outer portion of a wall of one of the tube and the conduit.

6. The conduit as defined in claim 1, further comprising a radially outwardly extending flange formed on an outer portion of a wall of one of the tube and the conduit.

7. The conduit as defined in claim 1, wherein a wall of one of the tube and the conduit includes an aperture formed therein for receiving the connecting structure formed on the other of the tube and the conduit.

8. The conduit as defined in claim 1, wherein one of the tube and the conduit includes a twist lock aperture formed therein for receiving the connecting structure formed on the other of the tube and the conduit.

9. The conduit as defined in claim 8, wherein the twist lock aperture is substantially L-shaped.

10. The conduit as defined in claim 1, wherein the tube is a clean air tube.

11. The conduit as defined in claim 1, wherein the sealing structure comprises at least one protuberance formed on a wall of one of the tube and the conduit, wherein the protuberance is adapted to sealingly engage a wall of the other of the tube and the conduit.

12. A conduit comprising:
a hollow conduit having a first end and a second end;
a hollow tube adapted to be connected to the first end of the conduit;
a connecting structure formed on one of the tube and the conduit, the connecting structure adapted to engage the other of the tube and the conduit to militate against a separation of the tube and the conduit, wherein a wall of one of the tube and the conduit includes an aperture formed therein for receiving the connecting structure formed on the other of the tube and the conduit; and
a sealing structure disposed between the tube and the conduit to facilitate a substantially fluid tight seal therebetween.

13. The conduit as defined in claim 12, wherein the connecting structure is a protuberance formed on an outer portion of a wall of one of the tube and the conduit.

14. The conduit as defined in claim 12, wherein the connecting structure is a locking tab formed on an outer portion of a wall of one of the tube and the conduit.

15. The conduit as defined in claim 12, further comprising a flange formed on an outer portion of a wall of one of the tube and the conduit.

16. The conduit as defined in claim 12, wherein one of the tube and the conduit includes a substantially L-shaped twist lock aperture formed therein for receiving the connecting structure formed on the other of the tube and the conduit.

17. The conduit as defined in claim 12, wherein the sealing structure comprises at least one protuberance formed on at least one of the tube and the conduit, wherein the protuberance is adapted to sealingly engage a wall of the other of the tube and the conduit.

18. A conduit comprising:
a hollow conduit having a first end and a second end;
a hollow tube adapted to be connected to the first end of the conduit;
a connecting structure formed on one of the conduit and the tube, the connecting structure adapted to engage the other of the conduit and the tube to militate against a separation of the conduit and the tube; and
a sealing structure disposed between the conduit and the tube to facilitate a substantially fluid tight seal therebetween.

19. The conduit as defined in claim 18, wherein a wall of one of the conduit and the tube includes an aperture formed therein for receiving the connecting structure formed on the other of the conduit and the tube.

20. The conduit as defined in claim 18, wherein the sealing structure comprises at least one protuberance formed on a wall of one of the conduit and the tube, wherein the protuberance is adapted to sealingly engage a wall of the other of the conduit and the tube.
